(19) United States
(12) Patent Application Publication
(10) Pub. No.: US 2021/0375077 A1
(43) Pub. Date: Dec. 2, 2021

(54) FAULT DIAGNOSIS DEVICE

(71) Applicant: HONDA MOTOR CO., LTD., Minato-ku, Tokyo (JP)

(72) Inventors: Naoki Kawahara, Minato-ku, Tokyo (JP); Koji Watanabe, Minato-ku, Tokyo (JP)

(21) Appl. No.: 17/281,594

(22) PCT Filed: Jul. 3, 2019
(86) PCT No.: PCT/JP2019/026509

§ 371 Date: Mar. 31, 2021

(30) Foreign Application Priority Data
Oct. 4, 2018 (JP) 2018-189043

(51) Int. Cl. G07C 5/08

(52) U.S. Cl. CPC G07C 5/085; G07C 5/0808; G07C 5/0825

(57) ABSTRACT

Provided is a fault diagnosis device capable of identifying the true location of a fault in a short length of time, regardless of mechanic experience. The present invention is a fault diagnosis device that diagnoses faults on the basis of fault codes recorded in an electronic controller of a vehicle, the device comprising: a storage unit for storing system information representing a system of a plurality of fault codes that are related to each other; an identifying unit for identifying a true fault code on the basis of the system information when a plurality of fault codes are recorded; and an output unit for outputting the identification results of the identification unit.

### TECHNICAL FIELD

The present invention relates to a failure diagnosis device (fault diagnosis device) configured to perform a failure diagnosis based on trouble codes recorded in electronic control units of a vehicle.

### BACKGROUND ART

In recent times, vehicles are equipped with various ECUs (electronic control units). In the case that failures occur in control related devices, the respective ECUs record trouble codes corresponding to such failures.

Hereinafter, the trouble codes may also be simply referred to as codes or DTCs (Diagnostic Trouble Codes). The DTCs are used when repairing the vehicle. For example, a mechanic (a technician or the like) in charge of repairs connects a failure diagnosis device to the vehicle, and identifies the locations of the failures based on the DTCs displayed on a screen.

Incidentally, a situation may occur in which a plurality of the ECUs individually record DTCs due to one failure. In such a case, the mechanic is required to identify the location of the failure based on a plurality of DTCs that are displayed on the screen of the failure diagnosis device. In Japanese Patent Publication No. 08-020340, a device is disclosed for identifying a failure location within a short time period even in the case that a plurality of DTCs are recorded. Such a device stores a table in which a priority ordering of the DTCs is designated in advance, and in the case that a plurality of DTCs are recorded, the priority ordering of the DTCs is displayed on a screen. The mechanic implements a failure diagnosis in accordance with the priority ordering of the DTCs.

### SUMMARY OF INVENTION

In the table disclosed in Japanese Patent Publication No. 08-020340, a priority ordering of the DTCs related to a basic control of the vehicle is given a higher order, and a priority ordering of the DTCs related to a corrective control (a control for correcting a result of the basic control) is given a lower order. However, in the case that a plurality of DTCs are recorded, a cause of the failure may not necessarily be the failure of a higher order basic control. For this reason, a possibility remains that unnecessary work and labor may be generated in the case of performing a failure diagnosis using the device of Japanese Patent Publication No. 08-020340.

The present invention has been devised taking into consideration the aforementioned problems, and has the object of providing a failure diagnosis device, which is capable of identifying a true location of a failure in a short time period without depending on the experience of a mechanic.

An aspect of the present invention is characterized by a failure diagnosis device configured to perform a failure diagnosis based on trouble codes recorded in electronic control units of a vehicle, the failure diagnosis device comprising:

a storage unit configured to store system information indicative of a system of a plurality of trouble codes that are related to each other;

an identification unit configured to identify a true trouble code based on the system information, in a case that the plurality of trouble codes are recorded; and an output unit configured to output an identification result of the identification unit.

According to the present invention, it is possible to identify a true location of a failure in a short time period without depending on the experience of a mechanic.

### BRIEF DESCRIPTION OF DRAWINGS

FIG. 1 is a configuration diagram of a vehicle serving as a failure diagnosis target, and a data collection device;

FIG. 2 is a configuration diagram of a failure diagnosis device and a server according to the present embodiment;

FIG. 3 is an explanatory diagram used to explain a first recording mode of DTCs;

FIG. 4 is an explanatory diagram used to explain a second recording mode of DTCs;

FIG. 5 is a configuration diagram of a system table;

FIG. 6 is a list diagram of systems included in the system table of FIG. 5;

FIG. 7 is a flowchart of main processing steps of a failure diagnosis process;

FIG. 8 is a flowchart of DTC identification processing steps of the failure diagnosis process;

FIG. 9 is an explanatory diagram used to explain a case in which the recorded DTCs span over a plurality of systems;

FIG. 10 is an explanatory diagram used to explain a case in which the recorded DTCs span over a plurality of systems; and

FIG. 11 is an explanatory diagram used to explain a case in which the recorded DTCs span over a plurality of systems.

### DESCRIPTION OF EMBODIMENTS

A preferred embodiment concerning a failure diagnosis device according to the present invention will be presented and described in detail below with reference to the accompanying drawings.

### 1. Configuration of Vehicle 80

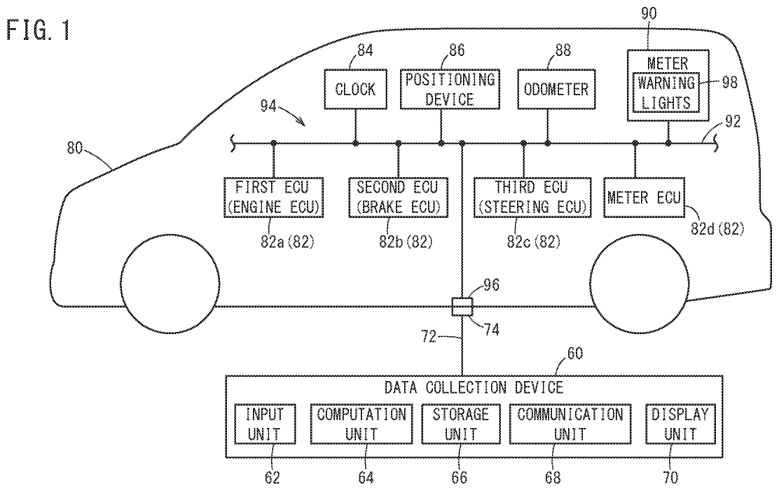

According to the present embodiment, the vehicle 80 serves as a failure diagnosis target. A description concerning the configuration of the vehicle 80 will be presented with reference to FIG. 1. The vehicle 80 is a gasoline vehicle having a driving engine. The vehicle 80 may also be a hybrid vehicle having a driving motor in addition to a driving engine, or an electric vehicle (including a fuel cell vehicle) having only a driving motor, or the like. Further, according to the present embodiment, although the vehicle 80 is assumed to be a four-wheeled vehicle, the vehicle 80 may also be a two-wheeled vehicle or a three-wheeled vehicle.

The vehicle 80 includes a plurality of ECUs 82 (electronic control units), a clock 84, a positioning device 86, an odometer 88, and a meter 90. As the plurality of ECUs 82, there are assumed to be four ECUs 82, including a first ECU 82a, a second ECU 82b, a third ECU 82c, and a meter ECU 82d. For example, the first ECU 82a is an engine ECU, and records DTCs when failures related to the engine control occur. The second ECU 82b is a brake ECU, and records DTCs when failures related to the brake control occur. The third ECU 82c is a steering ECU, and records DTCs when failures related to the steering control occur. The meter ECU 82d controls the meter 90, and displays warning lights 98 in accordance with the failures. The clock 84 clocks (measures the timing of) the date and time. The positioning device 86 measures the position of the vehicle 80 by way of satellite navigation and autonomous navigation. The odometer 88 integrates a traveled distance of the vehicle 80.

The respective ECUs 82, the clock 84, the positioning device 86, the odometer 88, and the meter 90 are connected via a communications bus 92, and thereby constitute an in-vehicle network 94 such as an F-CAN network, a B-CAN network, or the like. The communications bus 92 includes a data link connector 96 (for example, a USB connector) provided inside a vehicle cabin. A device external to the vehicle 80 (a data collection device 60) may be connected to the in-vehicle network 94 through the data link connector 96.

### 2. Configuration of Data Collection Device 60

A description concerning the configuration of the data collection device 60 which is connected to the in-vehicle network 94 will be presented with reference to FIG. 1. The data collection device 60 is connected to the in-vehicle network 94 via the data link connector 96 of the vehicle 80, and collects respective items of information including the DTCs. As shown in FIG. 1, the data collection device 60 includes an input unit 62, a computation unit 64, a storage unit 66, a communication unit 68, a display unit 70, and a data link cable 72.

The input unit 62 is constituted by a human-machine interface such as a touch panel, operation keys, and the like. The computation unit 64 is constituted by a processor such as a CPU or the like. The storage unit 66 is constituted by a ROM, a RAM, a hard disk, and the like. The display unit 70 is constituted by a display device equipped with a display screen.

When a connector 74 of the data link cable 72 is connected to the data link connector 96, the data collection device 60 is able to perform data communications with each of the ECUs 82 of the vehicle 80. In a state in which the connector 74 and the data link connector 96 are connected, and in accordance with an operation signal, which is output by the mechanic performing a predetermined operation on the input unit 62, the computation unit 64 collects the DTCs recorded in the respective ECUs 82, and displays the collected DTCs on the display unit 70. Further, in accordance with an operation signal, which is output by the mechanic performing a predetermined operation on the input unit 62, the computation unit 64 erases the DTCs recorded in the respective ECUs 82.

### 3. Configuration of Failure Diagnosis Device 10

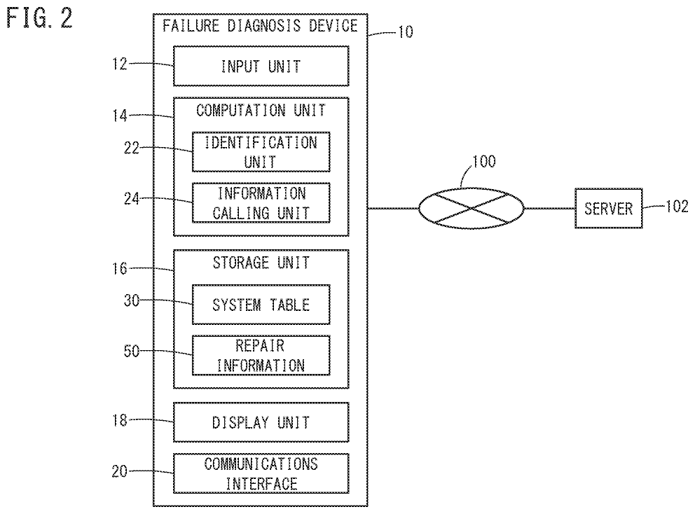

A description concerning the configuration of the failure diagnosis device 10 will be presented with reference to FIG. 2. The failure diagnosis device 10 is constituted, for example, by a computer (including a tablet computer or a smartphone). The failure diagnosis device 10 includes an input unit 12, a computation unit 14, a storage unit 16, a display unit 18, and a communications interface 20.

The input unit 12 is constituted by a human-machine interface such as a touch panel, a keyboard, a mouse, and the like. The computation unit 14 is constituted by a processor such as a CPU or the like. The storage unit 16 is constituted by a ROM, a RAM, a hard disk, and the like. The display unit 18 is constituted by a display device equipped with a display screen.

The computation unit 14, by executing programs stored in the storage unit 16, functions as an identification unit 22 and an information calling unit 24. Descriptions will be presented in item [6] below concerning the identification unit 22 and the information calling unit 24.

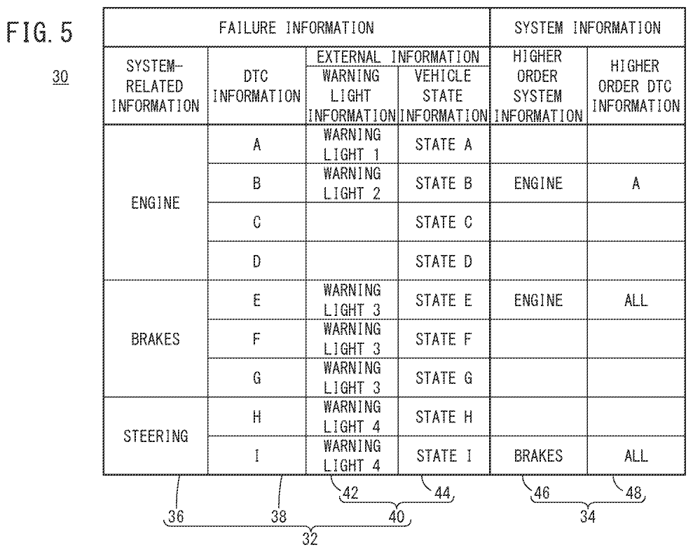

In addition to the programs executed by the computation unit 14, the storage unit 16 stores a system table 30 (see FIG. 5). Furthermore, the storage unit 16 stores repair information 50 corresponding to the DTCs. As the repair information 50, specified repair manuals may be stored. However, when the repair manuals are stored, a large storage capacity is required. According to the present embodiment, in order to avoid increasing the storage capacity of the storage unit 16, the repair manuals are stored in an external server 102, and the storage unit 16 stores, as the repair information 50, a URL of a website provided by the server 102.

### 4. Recording Modes of DTCs

When a failure occurs in devices of the vehicle 80, the ECUs 82 related to the devices record DTCs corresponding to the failure mode. When the mechanic connects the data collection device 60 to the vehicle 80, the computation unit 64 collects the DTCs recorded in all of the ECUs 82, and displays the DTCs on the display unit 70.

Incidentally, a plurality of DTCs may be displayed on the display unit 70 of the data collection device 60. The causes thereof are the recording modes of the DTCs in each of the ECUs 82. The recording modes of the DTCs are roughly divided into the following two patterns.

### [4.1. First Recording Mode]

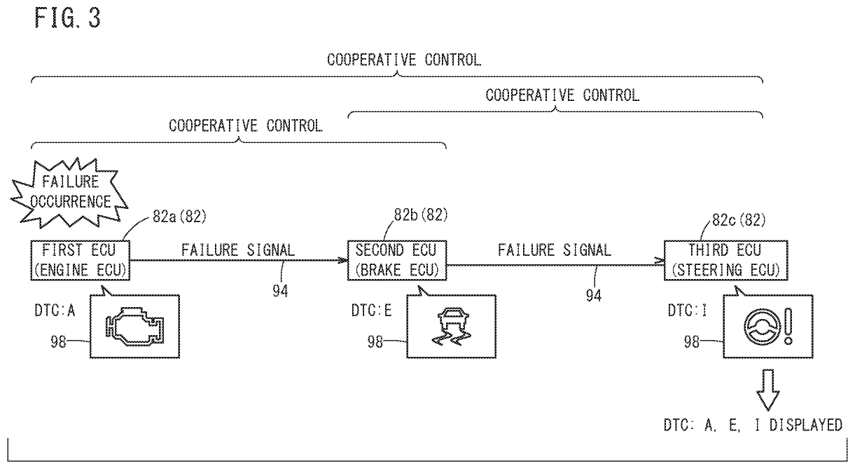

A description concerning a first recording mode of the DTCs will be presented with reference to FIG. 3. When a failure occurs in a device mounted on the vehicle 80, the first ECU 82a related to the device terminates the control using this device, and records a DTC (in this instance, code A) corresponding to the failure mode. At this time, the first ECU 82a outputs, to the in-vehicle network 94, a failure signal indicating that a failure corresponding to the code A has occurred.

The second ECU 82b performs a control, referred to as a so-called cooperative control, using the information output from the first ECU 82a. When receiving a failure signal output by the first ECU 82a, the second ECU 82b terminates the cooperative control, and records a DTC (in this instance, code E) corresponding to the failure mode (termination of the cooperative control). At this time, the second ECU 82b outputs, to the in-vehicle network 94, a failure signal indicating that a failure corresponding to the code E has occurred.

The third ECU 82c performs a cooperative control using the information output from the second ECU 82b. When receiving a failure signal output by the second ECU 82b, the third ECU 82c terminates the cooperative control, and records a DTC (in this instance, code I) corresponding to the failure mode (termination of the cooperative control). At this time, the third ECU 82c outputs, to the in-vehicle network 94, a failure signal indicating that a failure corresponding to the code I has occurred.

The meter ECU 82d receives failure signals output from the first ECU 82a, the second ECU 82b, and the third ECU 82c, and controls the meter 90. The meter 90 turns on warning lights 98 corresponding to the failures.

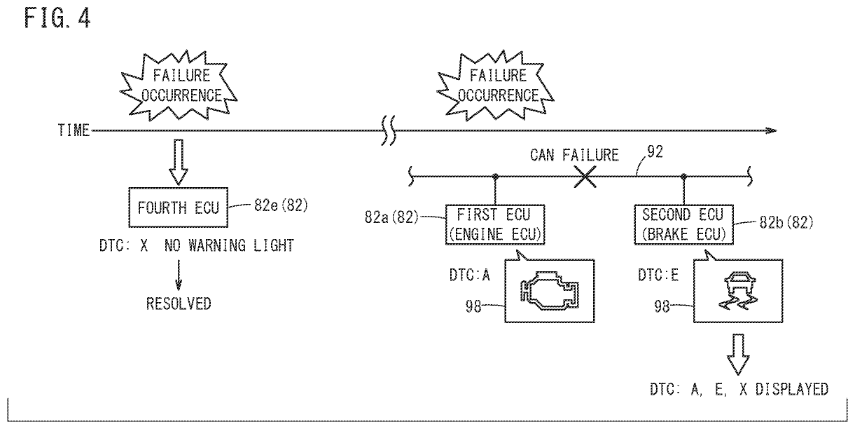

As described above, when a single failure occurs, the plurality of ECUs 82 may terminate the controls in a chained manner and fall into a failure state. Such a failure is referred to as a chain failure. When a chain failure occurs, each of the ECUs 82 records a DTC, respectively. When a mechanic connects the data collection device 60 to the vehicle 80 in a state in which a chain failure is occurring, a plurality of DTCs, in this instance, codes A, E, and I, are displayed on the display unit 70 of the data collection device 60.

[4.2. Second Recording Mode] A description concerning a second recording mode of the DTCs will be presented with reference to FIG. 4. When a failure occurs in a device mounted on the vehicle 80, a fourth ECU 82e related to the device terminates the control using the device that has failed, and records a DTC (in this instance, code X) corresponding to the failure mode. However, if the failure is resolved without being repaired, or in other words, if the failure is transient, the fourth ECU 82e resumes the control using the device for which the failure has been resolved. In this case, the fourth ECU 82e retains the DTC. In the case that a warning light 98 is not illuminated, the user often does not notice such a transient failure, and does not take the vehicle 80 to a dealer or the like. Therefore, the DTC in the fourth ECU 82e remains without being erased.

When a failure, for example, a CAN failure or the like, occurs after the transient failure has been resolved, the first ECU 82a records a DTC (in this instance, code A), and the second ECU 82b records a DTC (in this instance, code E). When a mechanic connects the data collection device 60 to the vehicle 80 in a state in which such a failure is occurring, a plurality of DTCs, in this instance, codes A and E, and a code X indicating that the transient failure has already been resolved, are displayed on the display unit 70 of the data collection device 60.

### 5. System Table 30

A description concerning the system table 30 that is stored in the storage unit 16 will be presented with reference to FIG. 5. As described in item [4] above, in the vehicle 80, in addition to a true DTC indicative of a failure that is actually occurring, DTCs indicative of failures occurring in a chain, or DTCs indicative of transient failures having occurred in the past may be recorded. In the case that a plurality of DTCs are recorded in the vehicle 80, the system table 30 is used to identify a true DTC from among the plurality of DTCs. The system table 30 is a list in which the DTCs and various information are associated with each other, and includes failure information 32 and system information 34.

The failure information 32 includes various information related to the failures, and more specifically, system-related information 36, DTC information 38, and external information 40. The external information 40 includes warning light information 42, and vehicle state information 44. The DTC information 38 indicates the DTCs assigned to the failures. The system-related information 36 indicates the vehicle systems in which failures corresponding to the DTCs occur. The warning light information 42 indicates the warning lights 98 which are illuminated when failures corresponding to the DTCs occur. Moreover, in the case of a failure that does not involve illumination of a warning light 98, the warning light information 42 is left blank. The vehicle state information 44 is indicative of states (faults) that appear in the vehicle 80 when failures corresponding to the DTCs occur.

The system information 34 is indicative of a system of a plurality of DTCs that are related to each other. The system information 34 not only indicates a related state between the DTCs, but also indicates the recording order of the plurality of DTCs that are recorded when a chain failure occurs. The system information 34 includes higher order system information 46, and higher order DTC information 48. The higher order system information 46 and the higher order DTC information 48 indicate the DTC that induces a failure when a chain failure occurs, namely, the DTC that is recorded earlier, and the vehicle system in which the failure corresponding to the DTC occurs.

A description will further be given concerning the system information 34. The higher order DTC of the code B shown in FIG. 5 is the code A. This implies that when the code A is recorded in the vehicle 80, next, the code B is recorded. The higher order DTCs of the code E shown in FIG. 5 are all of the codes A to D (ALL) of the engine system. This implies that when any one of the codes A to D of the engine system is recorded in the vehicle 80, next, the code E is recorded. The higher order DTCs of the code I shown in FIG. 5 are all of the codes E to G (ALL) of the brake system. This implies that when any one of the codes E to G of the brake system is recorded, next, the code I is recorded.

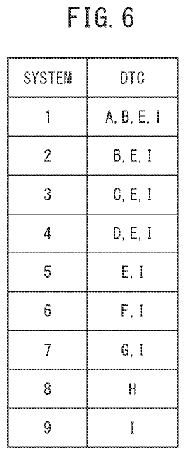

The system information 34 shown in FIG. 5 includes the nine systems shown in FIG. 6. In each of the systems shown in FIG. 6, the DTCs on the left side are the higher order DTCs. The term higher order as used herein implies that such data is recorded first in the event of a chain failure.

### 6. Procedure of Failure Diagnosis Process

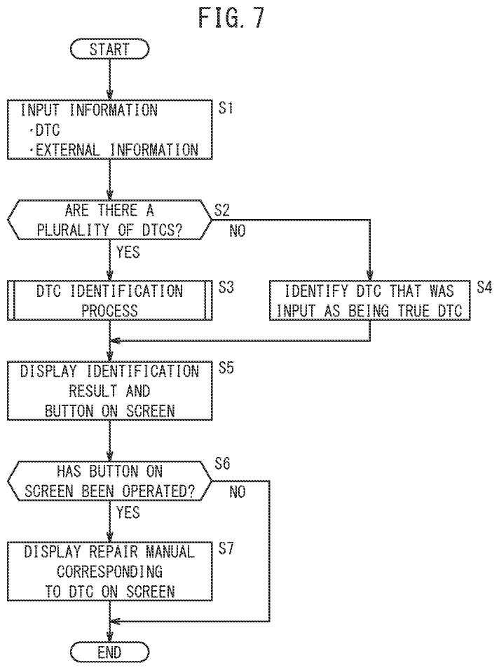

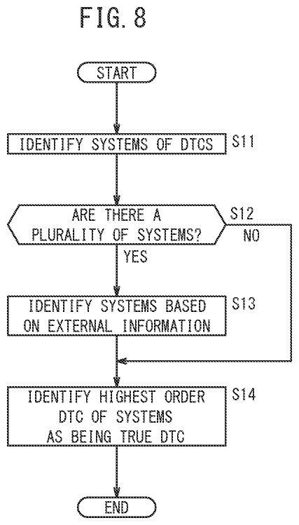

A description concerning a procedure of a failure diagnosis process performed by the failure diagnosis device 10 will be presented with reference to FIGS. 7 and 8. Prior to executing the failure diagnosis process by the failure diagnosis device 10, a mechanic performs the following operations. The mechanic connects the connector 74 of the data collection device 60 to the data link connector 96 of the vehicle 80, and performs a predetermined operation on the input unit 62. The computation unit 64 of the data collection device 60 collects the DTCs from each of the ECUs 82, and causes the DTCs to be displayed on the display unit 70. Next, the mechanic inputs the DTCs displayed on the display unit 70 of the data collection device 60, into the input unit 12 of the failure diagnosis device 10. Further, the mechanic inputs the type of the warning lights 98 displayed on the meter 90 of the vehicle 80, into the input unit 12 of the failure diagnosis device 10. Further, the mechanic inputs the vehicle state (a fault state or the like), which is asked from the user, into the input unit 12 of the failure diagnosis device 10. When the mechanic carries out such operations, the failure diagnosis device 10 initiates the main processing steps shown in FIG. 7.

### [6.1. Main Processing Steps]

In step S1, the input unit 12 inputs information to the computation unit 14. In this instance, the DTCs and the external information, which are input by the mechanic, are input. The external information refers to the type of the warning lights 98 and the vehicle state which are input by the mechanic into the input unit 12. When step S1 is completed, the process transitions to step S2.

In step S2, the identification unit 22 determines whether or not the input information includes a plurality of DTCs. In the case of a plurality of DTCs (step S2: YES), the process transitions to step S3. On the other hand, in the case that the number of DTCs is singular (step S2: NO), the process transitions to step S4.

Upon transitioning from step S2 to step S3, the identification unit 22 carries out a process of identifying the DTCs, for example, the DTC identification process shown in FIG. 8. The DTC identification process will be described later. On the other hand, upon transitioning from step S2 to step S4, the identification unit 22 identifies the DTC that was input as being the true DTC. When step S3 or step S4 is completed, the process transitions to step S5.

In step S5, the identification unit 22 outputs a display instruction to the display unit 18. The display unit 18 displays the identification result and a button on the screen in accordance with the display instruction from the identification unit 22. For example, the display unit 18 displays, on the screen, the system and the true DTC identified in step S3, or the true DTC identified in step S4. Furthermore, the display unit 18 displays, on the screen, a button for calling an operation manual corresponding to the DTC. At this time, the identification unit 22 reads out a URL corresponding to the true DTC from the repair information 50. When step S5 is completed, the process transitions to step S6.

In step S6, the information calling unit 24 determines whether or not a button displayed on the screen of the display unit 18 has been operated. If the button is operated (step S6: YES), the process transitions to step S7. On the other hand, if the button is not operated (step S6: NO), the series of processing steps is brought to an end.

Upon transitioning from step S6 to step S7, based on the URL read out by the identification unit 22, the information calling unit 24 accesses the website provided by the server 102 via the communications interface 20, and an external network 100 such as a public line or the like. Furthermore, the information calling unit 24 downloads the repair manual corresponding to the true DTC from the server 102, and outputs a display instruction to the display unit 18. In accordance with the display instruction from the information calling unit 24, the display unit 18 displays the repair manual on the screen. When step S7 is completed, the series of processing steps is brought to an end.

By understanding the true DTC, the mechanic is capable of identifying the failure and carrying out a repair thereon. Further, as necessary, the mechanic can refer to the repair manual and perform the repair.

### [6.2. DTC Identification Process]

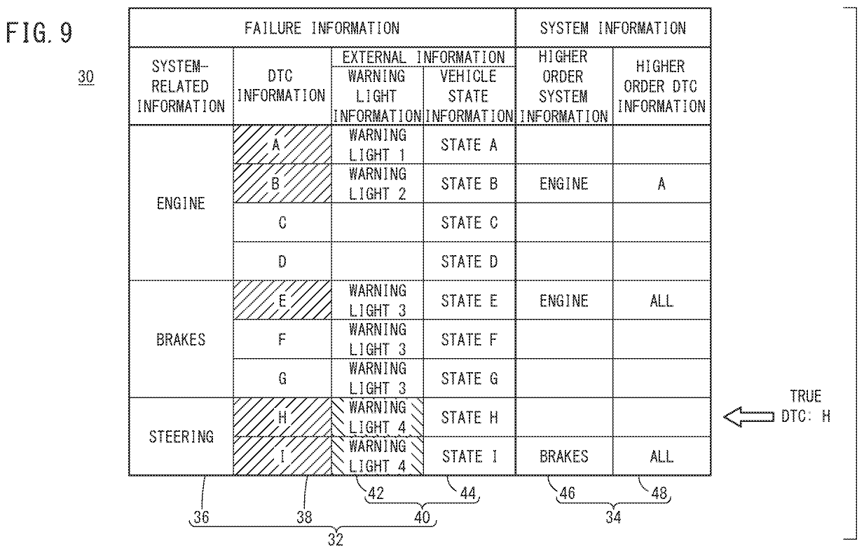

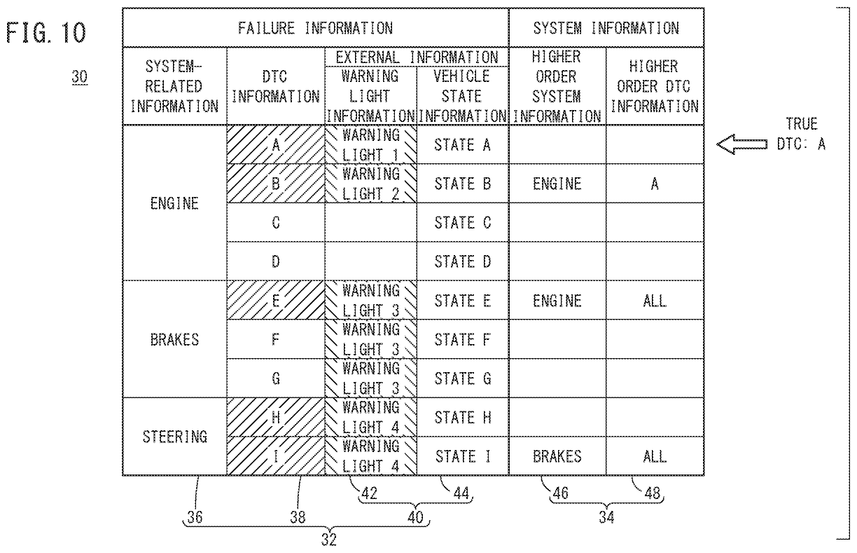

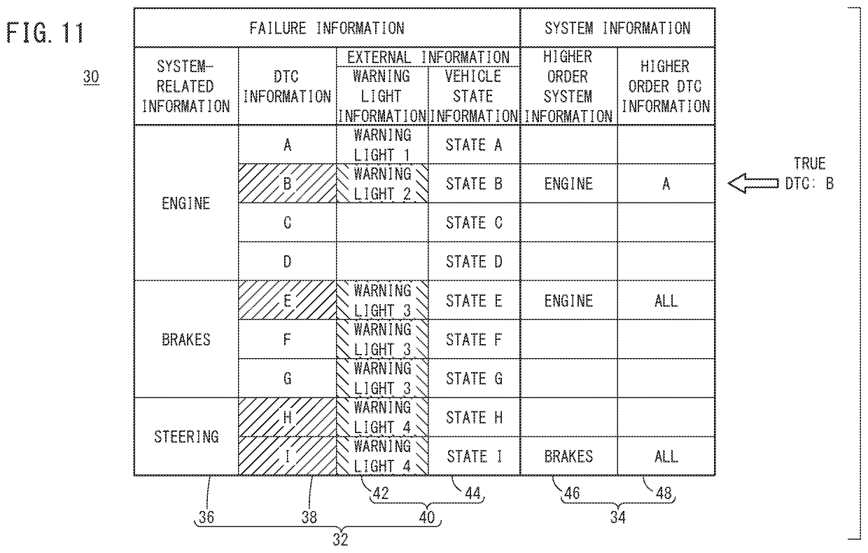

One example of the DTC identification process, which is performed in step S3 of FIG. 7, will be described with reference to FIG. 8. In step S11, the identification unit 22 compares the plurality of DTCs that were input with the system table 30, and identifies the systems of the DTCs. As explained in item [5] above, the system information 34 of the system table 30 shown in FIG. 5 includes the nine DTC systems shown in FIG. 6. For example, in the case that the DTCs of codes A, B, E, H, and I are input (see FIGS. 9 and 10), the identification unit 22 identifies the systems of the DTCs as the system 1 (A, B, E, and I) and system 8 (H). Further, in the case that the DTCs of codes B, E, H, and I are input (see FIG. 11), the identification unit 22 identifies the systems of the DTCs as the system 2 (B, E, and I) and system 8 (H). When step S11 is completed, the process transitions to step S12.

In step S12, the identification unit 22 determines whether or not there are a plurality of systems in the identification result of step S11. In the case that the number of systems is plural (step S12: YES), the process transitions to step S13. On the other hand, in the case that the number of systems is singular (step S12: NO), the process transitions to step S14.

In step S13, the identification unit 22 identifies the systems on the basis of the external information 40 (the warning light information 42, the vehicle state information 44). In this instance, the identification of the systems will be described with reference to FIGS. 9 to 11. In FIGS. 9 to 11, the DTC information 38 and the warning light information 42 shown in crosshatching signify the DTCs that were input in step S1 of FIG. 7, and more specifically, the DTCs recorded in the ECUs 82 of the vehicle 80.

For example, as shown in FIGS. 9 and 10, a case is assumed in which the DTCs of codes A, B, E, H, and I are input. As shown in FIG. 6, the DTC grouping of the codes A, B, E, H, and I includes the system 1 made up from codes A, B, E, and I, and the system 8 made up from code H. In the case that a failure (in this case, a chain failure) related to the system 1 is occurring in the vehicle 80, the meter 90 displays the warning lights 1 to 4 as shown in FIG. 10. On the other hand, in the vehicle 80, in the case that a failure related to the system 8 is occurring in the vehicle 80, the meter 90 displays only the warning light 4 as shown in FIG. 9. The identification unit 22 determines whether the type of the warning lights 98 input in step S1 is the warning light 1 through the warning light 4 (see FIG. 10), or only the warning light 4 (see FIG. 9), and identifies the systems of the DTCs pertaining to the failure that is currently occurring, based on the warning light information 42.

For example, as shown in FIG. 11, a case is assumed in which the DTCs of codes B, E, H, and I are input. As shown in FIG. 6, the DTC grouping of the codes B, E, H, and I includes the system 2 made up from codes B, E, and I, and the system 8 made up from code H. In the case that a failure (in this case, a chain failure) related to the system 2 is occurring in the vehicle 80, the meter 90 displays the warning lights 2 to 4 as shown in FIG. 11. On the other hand, in the vehicle 80, in the case that a failure related to the system 8 is occurring in the vehicle 80, the meter 90 displays only the warning light 4 (not shown). The identification unit 22 determines whether the type of the warning lights 98 input in step S1 is the warning light 2 through the warning light 4 (see FIG. 11), or only the warning light 4 (not shown), and identifies the systems of the DTCs pertaining to the failure that is currently occurring based on the warning light information 42.

Although in this instance an example, in which the systems are identified using the warning light information 42 as the external information 40, has been described, the systems can be identified using the vehicle state information 44 as the external information 40. In this case, the identification unit 22 determines one of the vehicle state information 44 to which the vehicle state that was input in step S1 corresponds, and identifies the systems of the DTCs pertaining to the failure that is currently occurring. Further, the systems can also be identified using both the warning light information 42 and the vehicle state information 44. When step S13 is completed, the process transitions to step S14.

In step S14, the identification unit 22 identifies the highest order DTC of the systems as being the true DTC. For example, in the case of the state shown in FIG. 9, the identification unit 22 identifies the highest order DTC of the system 8, namely, the code H, as being the true DTC. For example, in the case of the state shown in FIG. 10, the identification unit 22 identifies the highest order DTC of the system 1, namely, the code A, as being the true DTC. For example, in the case of the state shown in FIG. 11, the identification unit 22 identifies the highest order DTC of the system 2, namely, the code B, as being the true DTC. When step S14 is completed, the process transitions to step S5 shown in FIG. 7.

### 7. Modifications

[7.1. Modification 1] When the DTCs are recorded, each of the ECUs 82 records the DTCs in association with identifying information for identifying timings at which the failures have occurred. The identifying information is, for example, information of dates and times measured by the clock 84, information of the travel position of the vehicle 80 measured by the positioning device 86, and information of the traveled distance integrated by the odometer 88.

The computation unit 64 of the data collection device 60 collects the DTCs and the identifying information from each of the ECUs 82, and causes the DTCs and the identifying information to be displayed on the display unit 70. The mechanic inputs the DTCs and the identifying information displayed on the display unit 70 of the data collection device 60, into the input unit 12 of the failure diagnosis device 10. At this time, the DTCs and the identifying information are associated with each other.

Further, prior to executing the failure diagnosis process by the failure diagnosis device 10, the mechanic inputs a failure occurrence timing (the dates and time, the travel position, the traveled distance) of the vehicle 80, which is asked from the user, into the input unit 12 of the failure diagnosis device 10.

In step S13 of the DTC identification process shown in FIG. 8, the identification unit 22 determines the identification information that is close to the failure occurrence timing of the vehicle 80, which is asked from the user, and identifies the systems in which the DTCs associated with the identification information are included. Further, the systems can also be identified using the identification information, the warning light information 42, and the vehicle state information 44.

### [7.2. Other Modifications]

In the above-described embodiment and the modification thereof, a mechanic inputs information such as the DTCs and the like displayed on the data collection device 60, into the failure diagnosis device 10 via the input unit 12. Instead of this feature, data communications may be carried out between the data collection device 60 and the failure diagnosis device 10, and the information such as the DTCs and the like may be input from the data collection device 60 to the failure diagnosis device 10. In this case, the failure diagnosis device 10 is provided with a communication device (corresponding to the input unit 12) for carrying out wired or wireless data communications with the data collection device 60.

Further, data communications may be carried out between the vehicle 80 and the failure diagnosis device 10 without the intervention of the data collection device 60, and information such as the DTCs and the like may be input from the vehicle 80 to the failure diagnosis device 10. In this case, the failure diagnosis device 10 is provided with a communication device (corresponding to the input unit 12) for carrying out wired or wireless data communications with the data collection device 60.

Further, the failure diagnosis device 10 may be provided in the vehicle 80. In this case, the failure diagnosis device 10 is connected to the communications bus 92.

In the above-described embodiment and the modification thereof, the display unit 18 displays the true DTC identified by the identification unit 22, and the systems to which the true DTC pertains. Instead of this feature, the communication unit 68 (a communication circuit or the like) that carries out communications with a device other than the failure diagnosis device 10 may be provided, and the communication unit 68 may output, to an external device, the information indicating the true DTC identified by the identification unit 22, and the systems to which the true DTC pertains.

### 8. Technical Concepts Obtained from the Embodiment

A description will be given below concerning the technical concepts that can be grasped from the above-described embodiment and the modifications thereof.

An aspect of the present invention is characterized by the failure diagnosis device 10 that performs a failure diagnosis based on the trouble codes (DTCs) recorded in the electronic control units (ECUs 82) of the vehicle 80, comprising:

the storage unit 16 that stores the system information 34 indicative of a system of a plurality of the trouble codes that are related to each other;

the identification unit 22 that identifies a true trouble code based on the system information 34, in the case that the plurality of trouble codes are recorded; and the output unit (display unit 18) that outputs the identification result of the identification unit 22.

In accordance with the above-described configuration, the true failure code is identified on the basis of the system information 34. Therefore, even if a plurality of failure codes are recorded due to a chain failure, it is possible to identify the trouble code which corresponds to the higher order failure of the chain failure, namely, the true trouble code. Therefore, it is possible to identify a true location of the failure in a short time period without depending on the experience of a mechanic.

In the present invention, there may further be provided the input unit 12 that inputs, to the identification unit 22, the trouble codes that are recorded in the vehicle 80.

In the present invention, the system information 34 may include information indicative of a recording order in which the plurality of trouble codes (DTCs) are recorded accompanying a chain of failures; and

the identification unit 22 may identify, as the true trouble code, the trouble code that is first in the recording order from among the plurality of recorded trouble codes.

In the present invention,

the storage unit 16 may store the warning light information 42 indicative of the warning lights 98 corresponding to the trouble codes (DTCs); and

in the case that the trouble codes of a plurality of the systems are recorded, the identification unit 22 may identify the true trouble code based on the warning light information 42, and the information indicative of a warning light 98 that is actually illuminated.

In addition to the true trouble code, trouble codes related to failures that have occurred in the past may be recorded. In accordance with the above-described configuration, not only the system information 34 but also the warning light information 42 is used. Therefore, even if failure codes of a plurality of systems are recorded, the system in which the true failure code is included can be identified, and the true failure code can be identified from among the failure codes included within the identified system. Since the system can be identified in such a manner, work and labor can be carried out efficiently.

In the present invention,

identifying information for identifying the timings at which failures have occurred may be added to the trouble codes (DTCs); and

in the case that the trouble codes of a plurality of the systems are recorded, the identification unit 22 may identify the true trouble code based on the identifying information, and information indicative of the timing at which a failure has actually occurred.

In addition to the true trouble code, trouble codes related to failures that have occurred in the past may be recorded. In accordance with the above-described configuration, not only the system information 34 but also the identifying information is used. Therefore, even if failure codes of a plurality of systems are recorded, the system in which the true failure code is included can be identified, and the true failure code can be identified from among the failure codes included within the identified system. Since the system can be identified in such a manner, work and labor can be carried out efficiently.

In the present invention,

the storage unit 16 may store the fault information (the vehicle state information 44) indicative of fault states corresponding to the trouble codes (DTCs); and

in the case that the trouble codes of a plurality of the systems are recorded, the identification unit 22 may identify the true trouble code based on the fault information, and information indicative of a state of the fault that is actually occurring.

In addition to the true trouble code, trouble codes related to failures that have occurred in the past may be recorded. In accordance with the above-described configuration, not only the system information 34 but also the fault information (the vehicle state information 44) is used. Therefore, even if failure codes of a plurality of systems are recorded, the system in which the true failure code is included can be identified, and the true failure code can be identified from among the failure codes included within the identified system. Since the system can be identified in such a manner, work and labor can be carried out efficiently.

In the present invention, an output unit (the display unit 18) may display the recorded trouble codes in association with the system, together with displaying the true trouble code.

In accordance with the above-described configuration, a mechanic is capable of grasping not only the true trouble code, but also that there is a chain failure.

The failure diagnosis device according to the present invention is not limited to the embodiment described above, and it is a matter of course that various configurations could be adopted therein without departing from the essence and gist of the present invention.

What is claim is:

1. A failure diagnosis device configured to perform a failure diagnosis based on trouble codes recorded in electronic control units of a vehicle, the failure diagnosis device comprising:
a storage unit configured to store system information indicative of a system of a plurality of the trouble codes that are related to each other;
an identification unit configured to identify a true trouble code based on the system information, in a case that the plurality of trouble codes are recorded; and
an output unit configured to output an identification result of the identification unit.

2. The failure diagnosis device according to claim 1, further comprising an input unit configured to input, to the identification unit, the trouble codes that are recorded in the vehicle.

3. The failure diagnosis device according to claim 1, wherein:
the system information includes information indicative of a recording order in which the plurality of trouble codes are recorded accompanying a chain of failures; and
the identification unit identifies, as the true trouble code, the trouble code that is first in the recording order from among the plurality of recorded trouble codes.

4. The failure diagnosis device according to claim 1, wherein:
the storage unit stores warning light information indicative of warning lights corresponding to the trouble codes; and
in a case that the trouble codes of a plurality of the systems are recorded, the identification unit identifies the true trouble code based on the warning light information, and information indicative of a warning light that is actually illuminated.

5. The failure diagnosis device according to claim 1, wherein:
identifying information for identifying timings at which failures have occurred is added to the trouble codes; and
in a case that the trouble codes of a plurality of the systems are recorded, the identification unit identifies the true trouble code based on the identifying information, and information indicative of a timing at which a failure has actually occurred.

6. The failure diagnosis device according to claim 1, wherein:
the storage unit stores fault information indicative of fault states corresponding to the trouble codes; and
in a case that the trouble codes of a plurality of the systems are recorded, the identification unit identifies the true trouble code based on the fault information, and information indicative of a state of the fault that is actually occurring.

7. The failure diagnosis device according to claim 1, wherein the output unit displays the recorded trouble codes in association with the system, together with displaying the true trouble code.
